(19) United States
(12) Patent Application Publication
(10) Pub. No.: US 2007/0256025 A1
(43) Pub. Date: Nov. 1, 2007

(54) Mobile application menu system

(76) Inventors: Vincent Yen, Vancouver (CA); Frederick Ghahramani, Vancouver (CA)

Correspondence Address: Robert E. Krebs, THELEN REID & PRIEST LLP, P.O. Box 640640, San Jose, CA, 95164-0640, US

(21) Appl. No.: 11/414,409

(22) Filed: Apr. 28, 2006

(51) Int. Cl. G06F 3/00; G06F 9/00; G06F 17/00

(52) U.S. Cl. 715/764; 715/810; 715/835; 715/864

(57) ABSTRACT

A menu system for a multifunctional software application on a mobile phone with a keypad is provided, including a menu activatable by a predetermined key on the keypad, preferably the “#” key; said menu offering a plurality of selections laid out in rows of three; wherein said selections are selectable by actuation of a key on said keypad corresponding to the layout of the menu.

### FIELD OF THE INVENTION

This invention relates to software for operating mobile devices in general and particularly for menu systems for such devices in particular.

### BACKGROUND OF THE INVENTION

Most mobile devices, including mobile phones, have a limited user interface with which the user can control the phone. Typically the user interface will include a keypad to input the numbers “1” through “9” (which also serve to input the letters “A” through “Z”), as well as a “*” key and a “#” key.

Mobile phones also have menu systems to allow users to access the phone's features. For some of a certain features this menu system may be quite complex as the functions performed by the phones become ever more variable and complicated.

Most mobile phones allow a user to access the menu system by actuating a specific key on the phone that is expressly there for that purpose. The location, labelling, etc. of this key varies widely from phone to phone depending on the manufacturer and make of the mobile phone. The menus produced by each different type of mobile phone usually provide specific labelling of options and display such options in a specific order, often different from other makes of phone.

Mobile phones also usually have a pad or series of keys to allow a user to make menu selections. This may include four directional keys (up, down, right and left) and an “enter” or “select” key. Alternatively the four directional keys may be replaced by a touchpad responsive to the area pressed (top, bottom, right or left) to direct the menu option selected accordingly.

Some mobile phone menu related prior art includes U.S. Pat. No. 6,727,916 to Ballard, which discloses a menu system for a micro browser for assisting a user in participating in an interactive chat session (e.g. text messaging).

US Patent Application Publication No. 2003/0234814 to Salminen et al. discloses a cellular phone display in which popups are used to allow users to create messages and review received messages simultaneously.

US Patent Application Publication No. 2004/0056901 to March et al. discloses a “buddy list” to represent relationships to a user of a mobile phone.

US Patent Application Publication No. 2002/0030700 to Arnold discloses a menu system using directional controls (for example a joystick) to make selections.

US Patent Application Publication No. 2001/0006889 to Kraft discloses a message exchange session between several terminals that displays received messages immediately to the user (regardless of the user's activities).

US Patent Application Publication No. 2002/0080186 to Frederiksen discloses a menu system for a mobile phone in which selections are made using a roller as a selection key. The menu appears when the roller is pressed.

U.S. Pat. No. 6,366,602 to Crosby et al. discloses a menu system for mobile radiotelephones. The menu items appear in a list format.

U.S. Pat. No. 5,774,450 to Davidson et al. discloses a hierarchical menu system accessible through several specific keys (riot those on the keypad) on the mobile phone.

PCT Publication No. WO 97/50264 to Shim discloses a cellular phone with a built in editor, which includes the addition of several keys.

US Patent Application Publication No. 2002/0041292 to Son et al. discloses a menu system in which the user can graphically scroll through menu selections and view the position of the menu within a menu tree.

As users now go through many mobile phones in short time periods (and as mobile phones become more of a fashion accessory), what is needed is a cross platform, contextual menu system for mobile phones that is not dependent on phone specific keys.

### BRIEF SUMMARY OF THE INVENTION

A menu system for a multifunctional software application on a mobile phone with a keypad is provided including a menu activatable by a predetermined key on the keypad; said menu offering a plurality of selections; wherein said selections are selectable by actuation of a key on said keypad. The menu system may be laid out to correspond to the keys on said keypad by which said selections are selectable. The menu may include a section for display of context sensitive text.

The predetermined key is preferably the “#” key and the menu may offer six selections presented in two rows of three, and having a section for display of text presented below the menu.

The menu is preferably context sensitive and at least one selection in the menu remains in a consistent position and offers a consistent option regardless of the context of said menu.

Preferably, the “1” key provides a default activation option in the menu, and the “6” key provides a default “exit” option in the menu.

### BRIEF DESCRIPTION OF THE DRAWINGS

FIG. 1 is a front view of a mobile phone having a display according to the invention;

FIGS. 2 through 4 are views of displays on a mobile phone showing a menu according to the invention and its use;

FIGS. 5 and 6 are views of displays on a mobile phone showing a menu according to the invention and its use in a “Hot List” application;

FIGS. 7 and 8 are views of displays on a mobile phone showing a menu according to the invention and its use in a private messaging session;

FIGS. 9 and 10 are views of displays on a mobile phone showing a menu according to the invention and its use when deleting or blocking a user;

FIGS. 11 through 13 are views of displays on a mobile phone showing a menu according to the invention and its use outside a standard chat room;

FIGS. 14 through 16 are views of displays on a mobile phone showing a menu according to the invention and its use inside a chat room not created by the user;

FIGS. 17 through 19 are views of displays on a mobile phone showing a menu according to the invention and its use outside a user created chat room; and

FIGS. 20 through 22 are views of displays on a mobile phone showing a menu according to the invention and its use inside a chat room created by the user.

### DETAILED DESCRIPTION OF THE INVENTION

As used in this document, the following terms will have the following meanings:
“keypad” means the keys on a mobile device for the numerals “1” through “9”, “0”, “*” and the “#” key. These keys are typically, but need not be, arranged in four rows, with the “1”, “2” and “3” keys forming the first row, the “4”, “5” and “6” keys making up the second row, the “7”, “8” and “9” keys forming the third row, and the “*”, “0” and “#” keys forming the fourth, and final, row. The keypad keys can often be used to also represent the letters “A” through “Z”;
“keypad key” means a key on a keypad representing one of the numerals “1” through “9”, “0”, “*” or the “#” key; and
“phone specific key” or “specialty key” means a key on a mobile device designed for a specific purpose that is not a keypad key (as further described below). Examples include keys on the side of mobile phones for activating a voice call, keys positioned above the keypad to launch and navigate through a menu, and keys known as “power” keys.

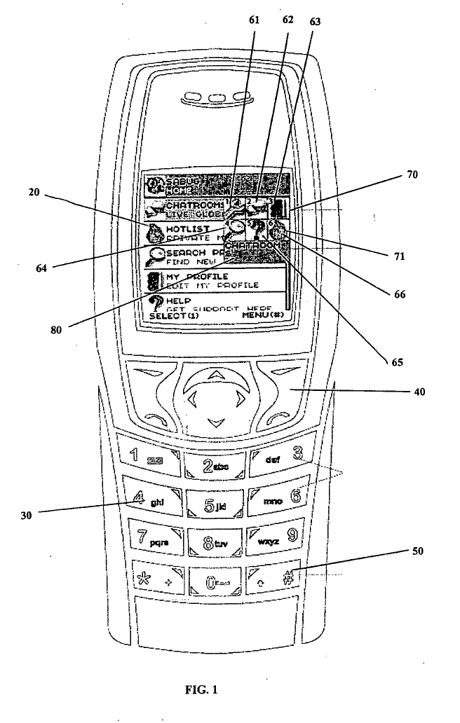

As seen in FIG. 1 a menu generally indicated as 10, according to the invention, is seen on the display 20 of mobile phone 1. Mobile phone 1 is representative of mobile phones commonly used, although the system according to the invention could be applicable on other mobile devices, such as PDAs. Mobile phone 1 includes display 20, keypad 30, and specialty keys 40. Keypad 30 includes keys for the numerals “1” through “9”, “0”, “*” and the “#” key 50. The letters “A” through “Z” are each represented on the keys for the numerals “1” through “9”.

Mobile phone 1 also includes specialty keys 40. Specialty keys 40 vary from phone to phone and are usually placed between keypad 30 and display 20, although frequently specialty keys 40 are also positioned on the side of mobile phone 1 or occasionally below keypad 30. For the purpose of this document specialty keys refer to all keys or other input means on phone 1 except for the keypad 30. Specialty keys 40 typically include keys to bring up the mobile phone's operating menu, and to select options from such menu. Also specialty keys may perform functions such as initiating a telephone call, hanging up and adjusting volumes or ring styles (vibrate, loud ring, etc.).

In the system according to the invention, mobile phone 1 may have two independent menu systems. The first system will be operated conventionally, using the specialty keys 40 to bring up a menu, to navigate through the menus and to select options. This menu will allow conventional control of the phones ring tones, and other settings.

In the system according to the invention, a multifunctional software application is provided for a mobile phone in which menu 10 is brought up when a user presses the “#” key 50 on mobile phone 1. The actuation of the “#” key 50 causes menu 10 to appear in a consistent location on display 20 regardless of the particular function of the multifunctional software the user is presently using. Menu 10 will thus remain thematically consistent throughout all display screens in the multifunctional application (somewhat analogous to a windows drop down menu as used on a personal computer).

The multifunctional software application on mobile phone 1 may be a “community” software application including features such as private and public lounges, image uploads, persistent profiles, presence indicators, instant messaging, and searching The menu system according to the invention could however be applied to many other multipurpose software applications for mobile phones.

Other keys on keypad 30 could be selected for use in bringing up menu 10, however the “#” key offers certain advantages. The numeral keys on keypad 30 are usually used to enter phone numbers and the “*” key often performs specific functions, such as dialing a 411 service or accessing voicemail. The “#” key tends not to be associated with such functions, and therefore is the key preferably used to bring up menu 10. A further benefit of using the “#” key is that most users are right handed, making it much easier for the user to reach the “#” key (usually placed on the bottom right of the keypad). This make the “#” key the most ergonomically comfortable selection for a menu actuation system.

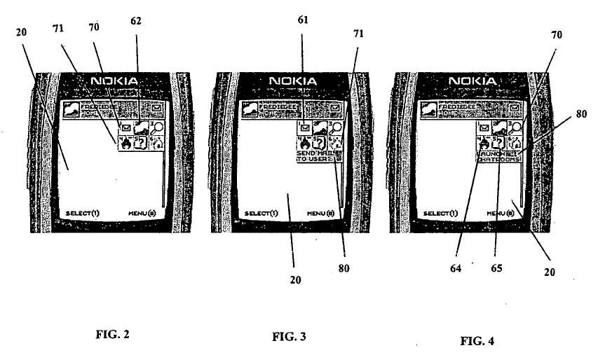

As seen in FIGS. 2 through 4, menu 10 preferably has a number of features. For example it should always appear in a specific portion of display 20 (for example in the top right as seen in the Figures), in the same size and position regardless of the particular function of the software application or of the particular phone being used.

Menu 10 as shown in the Figures includes six menu selections 61 through 66, laid out in two rows 70, 71 each comprising three selections. Each menu option 61 through 66 is associated with an image and a number from “1” through “6”.

Preferably, the default action, for example ‘Send’, ‘Post’, ‘Open’, or ‘View’, depending on the context of the particular function in use of the multifunction software application, is mapped to the “1” selection 61. The ‘Back’, ‘Cancel’, ‘Out’, ‘Home’, context sensitive ‘Return to Previous’ or default ‘Escape’ action applicable to the particular software application function in use when menu 10 is activated is mapped to the “6” selection 66. Preferably, but not necessarily, selection 65 (activated by the “5” key) provides contextual help for the user if this “Help” function is available.

Upon activating menu 10, a user can enter number “1” through “6” on the keypad 30 corresponding with the menu option 61 through 66 to activate such selection. In an alternative embodiment, the user can simply enter the corresponding number on the keypad 30 (without activating menu 10) to activate the same function. Although the menu presented herein provides the user with six options, laid out in two rows of three, other options are available, for example, two rows of two options, selectable through the number keys “1” through “4”, or three rows of three options, selectable through the number keys “1” through “9”. In a preferred embodiment the menu provides the users with “n” (e.g. 6) options presented and selectable through corresponding keys on the keypad (e.g. in rows of three corresponding to the rows on the keypad).

Below menu 10 is a section 80 for text, and in a preferred embodiment, two lines of text and/or an image. When appropriate, the text in section 80 provides information about the function that the user is positioned to activate. Preferably text is not displayed when menu 10 is initially activated, but is displayed as the user navigates through the menu options 61 through 66.

Once menu 10 has been brought up, entering any key (whether a display key 30 or specialized key 40) will make menu 10 disappear from display 20. Similarly, a period of inactivity (for example 3 seconds) when menu 10 is activated will result in the disappearance of menu 10 from display 20.

The user can also navigate menu 10 conventionally, using specialized keys 40 or other input means to navigate left or right or up or down in menu 10. When doing so section 80 will display text applicable to the menu option currently highlighted by the user. The user can then activate the selected function using menu 10 by entering either the corresponding numeral on keypad 30, or by entering the default ‘enter’ key (one of the specialty keys 40) on the phone. FIGS. 1 through 3 show representations of menu 10 changing as a user scrolls left or right. Preferably section 80 is consistent and does not increase the size of menu 10. Therefore text that cannot fit within the constraints of section 80 is preferably abbreviated.

It may be preferable, depending on the multifunctional software application, that menu 10 not be activatable during certain functions (for example when the user is on a phone call, as the “#” key may be used during the call as input) or when the user is editing the text entry fields in their user profile.

The following describes a preferred embodiment of the functions of menu 10 when used with a multifunctional “community” software application including functions such as private and public lounges, image uploads, persistent profiles, presence indicators, instant messaging, and searching.

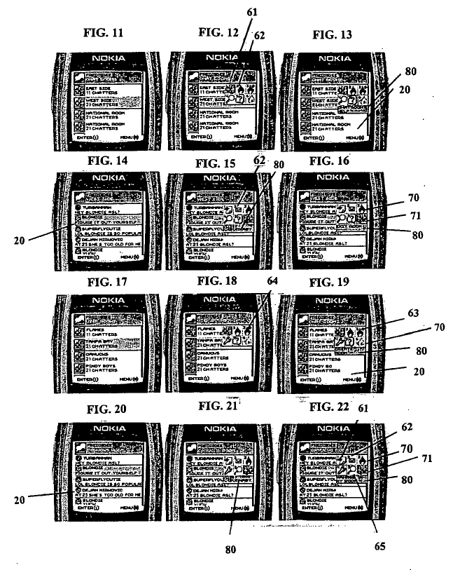

As seen in FIGS. 11 through 13 initial activation of menu 10 when the user is outside a standard chat room results in no optional text being displayed. Once a user starts to scroll through menu 10, the text descriptions appear in section 80. The selections 61 through 66 in menu 10 may be as follows:

| Selection | Text displayed | Function |
|---|---|---|
| 1 | Open | Opens the selected room or category |
| 2 | Hotlist | Jumps to the hotlist |
| 3 | Add to Hotlist | Adds the highlighted chat room or |
| | | category to the hotlist |
| 4 | Search | Jumps to a search screen |
| 5 | Chat Room Help | Opens the chat rooms help screen |
| 6 | Back | Returns to the main menu |

As seen in FIGS. 14 through 16, when the user is inside a chat room they did not create, at the activation of menu 10, section 80 contains an avatar of the highlighted user, along with their age, sex, and location. The location string may be abbreviated or clipped should it be too large to fit into section 80. Scrolling through menu 10 will replace the avatar and user information with the corresponding text for the highlighted item. Selections 61 through 66 may be as follows:

| Selection | Text displayed | Function |
|---|---|---|
| 1 | Post | Opens up a text box for user to |
| | | post message to room. |
| 2 | Mail | Opens up a text box to send |
| | | private message. |
| 3 | Hotlist | Jumps to the hotlist |
| 4 | Profile | Opens the highlighted user's profile |
| 5 | Help | Opens chat rooms help screen |
| 6 | Exit Room | Exits room, goes back up to the |
| | | chat room listing |

As seen in FIGS. 17 through 19, when the user is outside of a user created chat room, at the activation of menu 10, section 80 does not appear. Scrolling through menu 10 provides corresponding text for the highlighted selection to appear in section 80. Selections 61 through 66 may be as follows:

| Selection | Text displayed | Function |
|---|---|---|
| 1 | Open | Opens the selected room. |
| 2 | Hotlist | Jumps to the hotlist. |
| 3 | Add to Hotlist | Adds the highlighted chat room |
| | | to the hotlist |
| 4 | Build | Prompts user to name chat room, |
| | | and set settings |
| 5 | Help | Opens the chat rooms help screen |
| 6 | Back | Exits out of category/menu |

As seen in FIGS. 20 through 22, when the user is inside a chat room they created, at the activation of menu 10, section 80 contains an avatar of the highlighted user, along with their age, sex, and location (e.g. age 26, male and located in “Burnaby” as seen in the Figures). The location string may be clipped or abbreviated should it be too large to fit into section 80. Scrolling through menu 10 will replace the avatar and user information with the corresponding text for the highlighted selection. The selections are similar to those described when the user is within a static chat room they did not create except that if the user has operator status in the chat room, selection 4 (64) will provide the “Build” function (and the text displayed in space 80 will read as “Build”) which allows the user to manipulate the chat room.

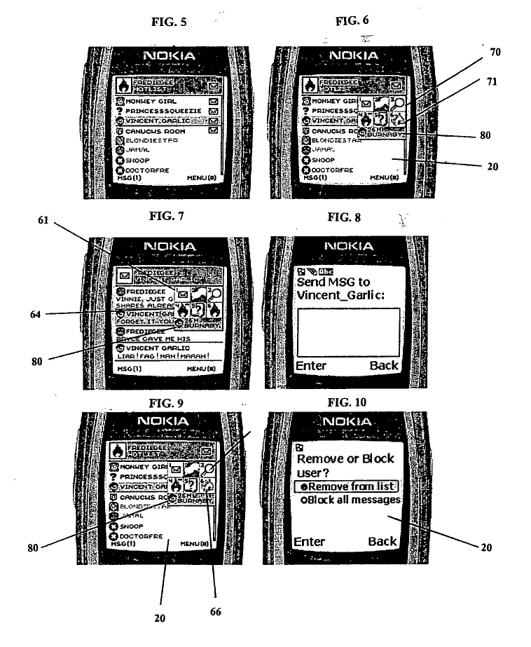

In a preferred embodiment, multifunction software application may include “hot lists”, listing a variety of elements. When menu 10 is activated, its contents will change depending on the element which is being scrolled over. For example if the user is scrolling over an element that is an online or offline friend, as seen in FIGS. 5 and 6, the following menu options may appear:

| Selection | Text displayed | Function |
|---|---|---|
| 1 | Message | Opens private message window |
| | | with highlighted user. |
| 2 | Chat Room | Jumps to chat room listing. |
| 3 | View Profile | Loads the highlighted users' |
| | | profile |
| 4 | Remove | Loads a ‘ban vs. remove’ prompt |
| 5 | Help | Loads the hotlist help screen |
| 6 | Home | Jumps to the home screen |

The optional text in this mode will at default (when menu 10 is first activated) contain the age, sex, and location of the highlighted friend—until the user starts to scroll menu 10, at which point the section 80 displays the descriptive text for the scrolled over menu selection.

If the user is navigating over a bookmarked chat room, menu 10 selections may be as follows:

| Selection | Text displayed | Function |
|---|---|---|
| 1 | Post | Opens the highlighted chat room. |
| 2 | Chat Room | Jumps to chat room listing. |
| 3 | Build/Manage | If user possesses operator status, |
| | | the ‘build/manage’ icon is |
| | | present. If not, then selection 3 |
| | | changes to display the user's |
| | | profile and avatar |
| 4 | Remove | Removes the bookmark from the hotlist |
| 5 | Help | Loads the hotlist help screen |
| 6 | Home | Jumps to the home screen |

Section 80, when menu 10 is activated will at default contain the number of chatters presently in the chat room highlighted. This information will only remain on the screen until the user starts to scroll menu 10.

If the user is scrolling over a blocked user as seen in FIGS. 9 and 10, menu 10 selections may be as follows:

| Selection | Text displayed | Function |
|---|---|---|
| 1 | View Profile | View the blocked user's profile |
| 2 | Add | Unblock user and adds him to the chat room |
| 3 | Remove | Permanently remove blocked user from list |
| 4 | Chat Room | Jumps to chat room listing |
| 5 | Help | Loads the hotlist help screen |
| 6 | Home | Jumps to the home screen |

If the user is engaged in a one-on-one private message session as seen in FIGS. 7 and 8, menu 10 selections may be as follows:

| Selection | Text displayed | Function |
|---|---|---|
| 1 | Message | Opens a text entry window to post message |
| 2 | Chat Room | Jumps to chat room listing. |
| 3 | View Profile | Loads the users' profile |
| 4 | Remove | Loads the ‘ban v. remove’ prompt |
| 5 | Help | Loads the hotlist help screen |
| 6 | Hotlist | Jumps back into hotlist |

If the user is viewing a user profile, menu 10 selections may be as follows:

| Selections | Text displayed | Function |
|---|---|---|
| 1 | Message | Open a text entry window to post message |
| 2 | Hotlist | Adds the user to the hotlist |
| 3 | Chat Rooms | Jumps to chat rooms |
| 4 | Hot List | Jumps to hotlist |
| 5 | Help | Loads the help screen |
| 6 | Back | Jumps back preceding screen |

If the user is viewing search results after conducting a search, menu 10 selections may be as follows:

| Selection | Text displayed | Function |
|---|---|---|
| 1 | View | View user's profile |
| 2 | Message | Opens text box to send user a message |
| 3 | Hotlist | Adds user to hotlist |
| 4 | Hot List | Jumps to hotlist |
| 5 | Help | Loads the hotlist help screen |
| 6 | Back | Jumps back preceding screen |

If the user is on the search screen, menu 10 selections may be as follows:

| Selections | Text displayed | Function |
|---|---|---|
| 1 | Edit | Edit the highlighted element |
| 2 | Search | Submit search |
| 3 | Chatrooms | Jump to chat rooms |
| 4 | Hot List | Jumps to hotlist |
| 5 | Help | Loads the help screen |
| 6 | Back | Jumps back to preceding screen |

The above described menu system can be implemented as a series of instructions stored on computer readable memory within a mobile device, such as RAM. The series of instructions may be present in a carrier wave embodying a computer data signal to communicate the instructions to a mobile device, which when executed by a processor within the mobile device carry out the menu system.

Although the particular preferred embodiments of the invention have been disclosed in detail for illustrative purposes, it will be recognized that variations or modifications of the disclosed apparatus lie within the scope of the present invention. In particular the uses and embodiments of the menu ad selections listed above are for illustrative purposes and the menu according to the invention has use with a wide variety of multifunction software applications.

The invention claimed is:

1. A menu system for a multifunctional software application on a mobile phone with a keypad comprising a menu activatable by a predetermined key on the keypad; said menu offering a plurality of selections; wherein said selections are selectable by actuation of a key on said keypad.

2. The menu system of claim 1 wherein the menu is laid out to correspond to the keys on said keypad by which said selections are selectable.

3. The menu system of claim 2 wherein said menu includes a section for display of context sensitive text.

4. The menu system of claim 3 wherein said predetermined key is the “#” key.

5. The menu system of claim 4 wherein said menu offers six selections presented in two rows of three.

6. The menu system of 5 wherein said section for display of text is presented below said menu.

7. The menu system of claim 6 wherein said menu is context sensitive.

8. The menu system of claim 7 wherein at least one selection in said menu remains in a consistent position and offers a consistent option regardless of the context of said menu.

9. The menu system of claim 8 wherein the “1” key selects a default forward action of said menu selections.

10. The menu system of claim 9 wherein the “6” key selects the default exit action of said menu selections.

11. A mobile device having a keypad and a plurality of specialty keys, comprising:
a) a first menu system, said first menu system activatable by a first specialty key, said first menu system navigable by said specialty keys; and
b) a second menu system activatable by a predetermined key on the keypad; said menu offering a plurality of selections; wherein said selections are selectable by actuation of a key on said keypad.
